(19) United States
(12) Patent Application Publication
(10) Pub. No.: US 2010/0073286 A1
(43) Pub. Date: Mar. 25, 2010

(54) Computer input device with time-difference-type bi-coordinate output, time-difference-type data input processing method, and sensor thereof

(75) Inventors: Tsung-Hsi Lin, Taipei (TW); Chien-Mo Lai, Taipei (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Taipei (TW)

(21) Appl. No.: 12/382,505

(22) Filed: Mar. 18, 2009

(30) Foreign Application Priority Data
Sep. 24, 2008 (TW) 097136762

(51) Int. Cl. G09G 5/08

(52) U.S. Cl. 345/157

(57) ABSTRACT

A computer input device with a time-difference-type bi-coordinate output, a time-difference-type data input processing method, and a sensor thereof. The computer input device includes a first light source for producing a first projecting beam in an alternating on and off manner; a second light source for producing a second projecting beam when the first light source is turned off; and a sensor module. The sensor module includes an optical signal receiving region for receiving the first projecting beam to obtain a first image data and receiving the second projecting beam to obtain a second image data; a control unit for comparing the first image data obtained at different time points to compute a first displacement data and comparing the second image data obtained at different time points to compute a second displacement data; and a storage unit for storing the first displacement data and the second displacement data.

### CROSS-REFERENCE TO RELATED APPLICATIONS

This non-provisional application claims priority under 35 U.S.C. §119(a) on Patent Application No(s). 097136762 filed in Taiwan, R.O.C. on Sep. 24, 2008 the entire contents of which are hereby incorporated by reference.

### BACKGROUND OF THE INVENTION

1. Field of Invention

The present invention relates to a computer input device and a data input processing method thereof, and more particularly to a computer input device with a time-difference-type bi-coordinate output, a time-difference-type data input processing method, and a sensor thereof.

2. Related Art

A computer input device generally refers to a hardware device capable of inputting a coordinate displacement signal to a computer device (for example, a personal computer, a notebook computer, or a personal digital assistant (PDA)). There are a variety of computer input devices, such as mice, trackball devices, touch pads, handwriting pads, and joysticks. Besides inputting the coordinate displacement signal to the computer device in accordance with a user's movement, the mouse is also equipped with a wheel for controlling a vertical or horizontal scroll of a Windows interface, and a micro-switch is further disposed beneath the wheel. Therefore, the user may issue a conformed instruction by pressing the wheel, and the mouse becomes the most popular human-machine interface in the current application of the Windows interface.

Nowadays, the mouse has been widely used in operating and controlling the Windows interface of a computer apparatus, and become one of the peripheral hardware devices indispensable for surfing the internet. Currently, the latest page curling device on the computer input device is a means with an optical sensing window. The principle of the optical sensing window can be categorized into two types: image comparison and optical refraction comparison. Such products may be found, for example, in the GENIUS TRAVELER 515 mouse.

Though the above computer input device with an optical sensing window greatly facilitates the operation, the fabrication cost of the computer input device is increased due to the adoption of two optical sensor modules (one to be used by the optical sensing window and the other for controlling the mouse pointer), and the power consumption also rises accordingly. Further, the volume of the computer input device has to be enlarged to accommodate the two optical sensor modules.

Therefore, it is the problem in urgent need of solutions to provide a computer input device low in cost and power consumption while having a small volume.

### SUMMARY OF THE INVENTION

In order to solve the above problem, the present invention is directed to a computer input device with a time-difference-type bi-coordinate output, a time-difference-type data input processing method, and a sensor thereof. Two sets of light sources are controlled sequentially to scan an image data in an alternating time difference manner, so as to reduce the power consumption of the computer input device. Moreover, one optical sensor module is used to detect the image data and compute a displacement data, so as to lower down the fabrication cost and reduce the volume of the computer input device.

Therefore, a computer input device with a time-difference-type bi-coordinate output is provided. The device includes a first light source for producing a first projecting beam in an alternating on and off manner; a second light source for producing a second projecting beam when the first light source is turned off and stopping producing the second projecting beam when the first light source is turned on; and a sensor module for receiving the first projecting beam and the second projecting beam. The sensor module includes an optical signal receiving region for receiving the first projecting beam to obtain a first image data and receiving the second projecting beam to obtain a second image data; a control unit for sequentially controlling the on and off of the first light source and the second light source in a time difference manner, comparing the first image data obtained by the optical signal receiving region at different time points to compute a first displacement data, and comparing the second image data obtained by the optical signal receiving region at different time points to compute a second displacement data; and a storage unit for storing the first displacement data and the second displacement data.

Further, a time-difference-type data input processing method of the computer input device is provided and applicable to an input processing between the computer input device with an optical sensing window and a computer. The method includes the steps of: turning on a first light source to produce a first projecting beam to the optical sensing window; providing a sensor module to receive a reflected light of the first projecting beam, so as to obtain a first image data; turning off the first light source, and turning on a second light source to produce a second projecting beam to a working surface; receiving a reflected light of the second projecting beam by the sensor module, so as to obtain a second image data; providing a control unit to compare the first image data obtained at different time points to compute a first displacement data, and compare the second image data obtained at different time points to compute a second displacement data; and storing the first displacement data and the second displacement data into a storage unit.

Moreover, a sensor with a time-difference-type bi-coordinate output is also provided. The sensor includes a first optical module for producing a first projecting beam to an optical sensing window in an alternating on and off manner; a second optical module for producing a second projecting beam to a working surface when the first optical module is turned off and stopping producing the second projecting beam to the working surface when the first optical module is turned on; and a sensor module for sequentially controlling the alternating on and off of the first and the second optical modules, and receiving a reflected light of the first projecting beam and a reflected light of the second projecting beam.

Through the computer input device with a time-difference-type bi-coordinate output, the time-difference-type data input processing method, and the sensor thereof, two sets of light sources are utilized to alternately scan two different working surfaces in a time difference manner so as to obtain a desired image data. Then, a displacement coordinate data of each working surface is computed and stored in different registers. Finally, two coordinate values are selectively read by a microcontroller through different register addresses, respectively, and resolved into two different functions output to the computer end. In the present invention, as only one set of light source is driven to scan the image data at a time, the power is saved compared with the conventional way of driving two sets of light sources to scan the image data for a long time. Besides, the present invention only requires one optical sensor module, so that the fabrication cost of the computer input device is lowered, and the volume of the computer input device is also reduced.

### BRIEF DESCRIPTION OF THE DRAWINGS

The present invention will become more fully understood from the detailed description given herein below for illustration only, and thus is not limitative of the present invention, and wherein:

FIG. 1 is a schematic view of a computer system according to the present invention.

FIG. 2 is a block diagram of a sensor with a time-difference-type bi-coordinate output according to the present invention.

FIG. 3A is a schematic view of an optical path according to a first embodiment of the present invention.

FIG. 3B is a schematic view of another optical path according to the first embodiment of the present invention.

FIG. 4A is a schematic view of an optical path according to a second embodiment of the present invention.

FIG. 4B is a schematic view of another optical path according to the second embodiment of the present invention.

FIG. 5 is a flow chart of a time-difference-type data input processing method of a computer input device according to the present invention.

### DETAILED DESCRIPTION OF THE INVENTION

The computer input device disclosed by the present invention includes, but not limited to, a computer peripheral input device such as a mouse, a trackball, a touch pad, or a game controller, and can be built in an electronic device with a Windows interface, for example, in a notebook computer, a PDA, a digital photo frame, or a cell phone to provide functions related to the user operation. However, the accompanying drawings are for reference and illustration only, instead of limiting the present invention. In the following description of the invention, the most preferred embodiments are provided with a mouse as the computer input device and a desktop computer as a computer device.

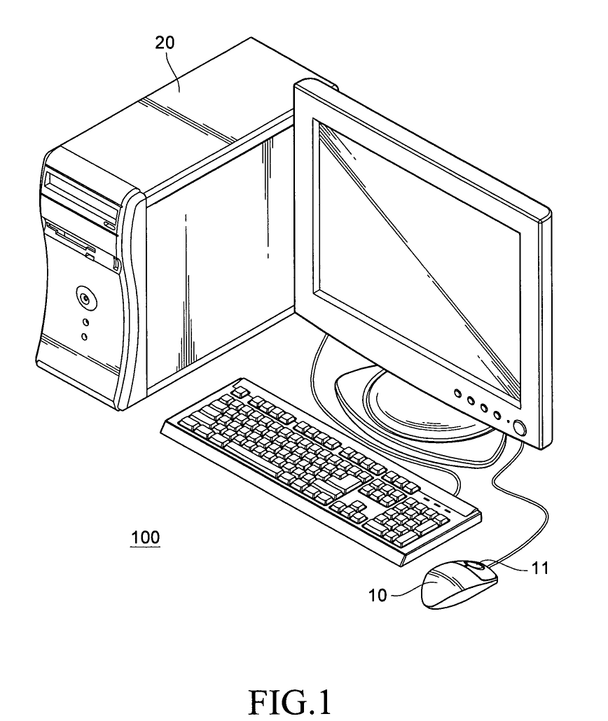

FIG. 1 is a schematic view of a computer system according to the present invention. As shown in FIG. 1, the computer system 100 includes a computer input device 10 and a computer device 20. The computer input device 10 is a mouse, and the computer device 20 is a desktop computer. In the conventional art, the mouse establishes a signal connection with the desktop computer in a wired or wireless manner. When the mouse is moved on a working surface, the displacement of the mouse on the surface is computed in a mechanical or optical manner, and transformed into a displacement signal to be transmitted to the desktop computer for controlling the cursor of an operating system (for example, a Windows operating system) of the desktop computer to move on the Windows interface. Further, an optical sensing window 11 is set on the mouse to replace the conventional wheel. When a user contacts the optical sensing window 11 with a finger or any other object, an image of the finger or object is captured through a construction of the following embodiments, and at least one corresponding control signal is produced.

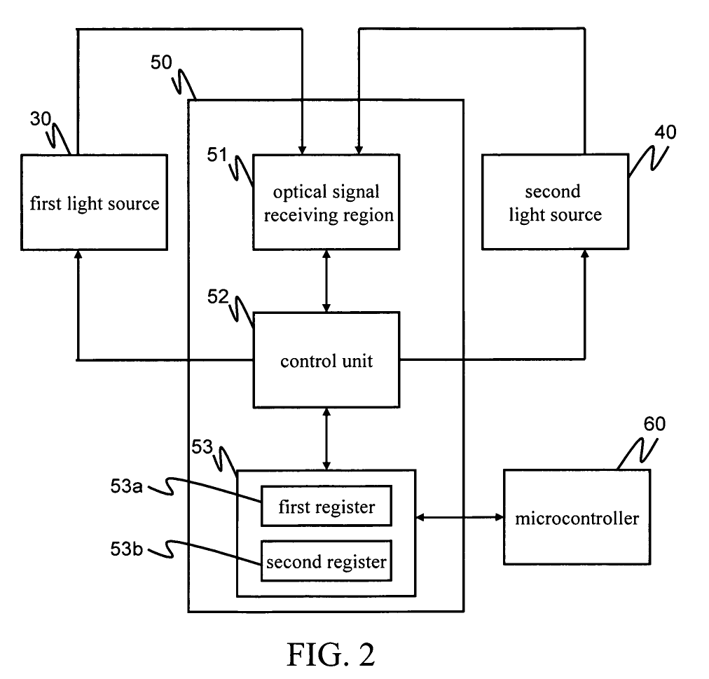

FIG. 2 is a block diagram of a sensor with a time-difference-type bi-coordinate output according to the present invention. As shown in FIG. 2, the sensor of the present invention includes a first light source 30, a second light source 40, and a sensor module 50. In the present invention, the sensor may be placed in a computer input device 10 and electrically connected to a microcontroller 60.

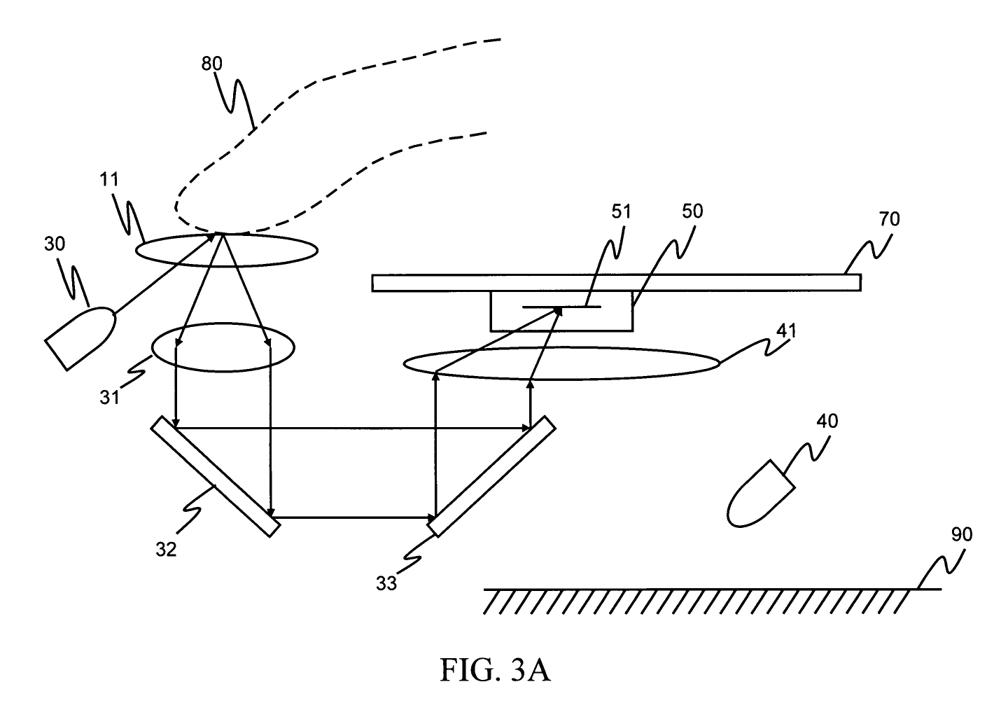

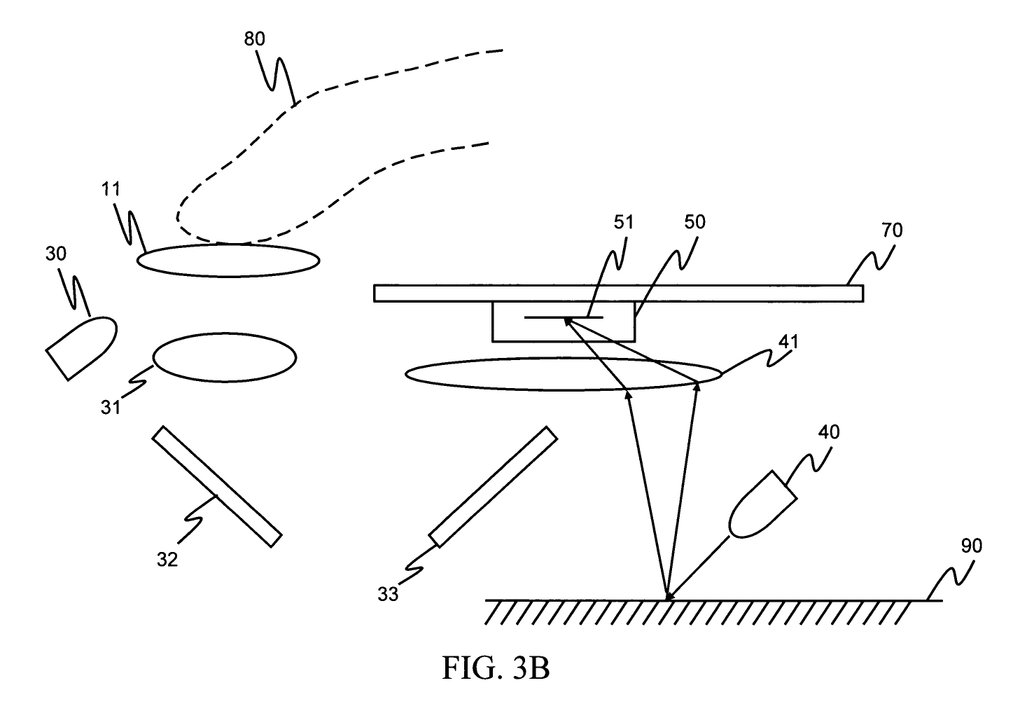

The first light source 30 produces a first projecting beam to the optical sensing window 11 in an alternating on and off manner, as shown in FIG. 3A. The first light source 30 is, for example, a light emitting diode (LED) or a laser diode.

The second light source 40 produces a second projecting beam to a motion plane when the first light source 30 is turned off, as shown in FIG. 3A, and stops producing the second projecting beam to the working surface when the first light source 30 is turned on. The second light source 40 is, for example, an LED or a laser diode. The first light source 30 and the second light source 40 are of the same wavelength or of different wavelengths.

The sensor module 50, including an optical signal receiving region 51, a control unit 52, and a storage unit 53, receives the first projecting beam and the second projecting beam.

The optical signal receiving region 51 receives the first projecting beam to obtain a first image data. The optical signal receiving region 51 receives the second projecting beam to obtain a second image data. The optical signal receiving region 51 may be an image detection sensor, such as a charged coupled device (CCD) or a complementary metal-oxide semiconductor (CMOS), for detecting an image change caused by a finger movement. Similarly, the optical signal receiving region 51 may also be a radiation detection sensor for detecting a physical property change after a light refraction, so as to obtain a corresponding image data.

The control unit 52 is connected to the optical signal receiving region 51. The control unit 52 sequentially controls the on and off of the first light source 30 and the second light source 40 in a time difference manner. The control unit 52 compares the first image data obtained by the optical signal receiving region 51 at different time points to compute a first displacement data, and compares the second image data obtained by the optical signal receiving region 51 at different time points to compute a second displacement data.

The storage unit 53 is connected to the control unit 52, for storing the first displacement data and the second displacement data. The storage unit 53 includes a first register 53a for storing the first displacement data and a second register 53b for storing the second displacement data.

The microcontroller 60 is connected to the storage unit 53, for reading the first displacement data and the second displacement data. The microcontroller 60 communicates with the computer device 20, and transmits the read first and second displacement data to the computer device 20 for subsequent processing.

FIG. 3A is a schematic view of an optical path according to a first embodiment of the present invention. As shown in FIG. 3A, the computer input device 10 generally includes an optical sensing window 11, a first light source 30, a first lens 31, a first reflecting mirror 32, a second reflecting mirror 33, a second light source 40, a second lens 41, a sensor module 50, and a circuit board 70. Further, in the first embodiment, the wavelengths of the first light source 30 and the second light source 40 may be identical or not.

The first lens 31 and the optical sensing window 11 are substantially disposed in parallel. The first reflecting mirror 32 and the first lens 31 are set at an angle of approximately 45°. The second reflecting mirror 33 and the first reflecting mirror 32 are generally arranged in a mirror image relationship. The second lens 41 is disposed above the second reflecting mirror 33. The sensor module 50 is disposed above the second lens 41 and located on a lower surface of the circuit board 70.

First of all, the control unit 52 sequentially controls the on and off of the first light source 30 and the second light source 40 in a time difference manner. When the first light source 30 is turned on, the second light source 40 is turned off. At this point, the first light source 30 produces a first projecting beam to the optical sensing window 11. Then, the first projecting beam is irradiated to a finger 80 and reflected to the first lens 31. The first lens 31 refracts the first projecting beam to the first reflecting mirror 32. Next, the first reflecting mirror 32 reflects the first projecting beam passing through the first lens 31 to the second reflecting mirror 33. The second reflecting mirror 33 reflects the first projecting beam reflected by the first reflecting mirror 32 to the second lens 41.

The second lens 41 is disposed between the second reflecting mirror 33 and the sensor module 50, for refracting the first projecting beam reflected by the second reflecting mirror 33 to the optical signal receiving region 51. The optical signal receiving region 51 receives the first projecting beam to obtain the first image data.

Next, when the finger 80 is moving on the optical sensing window 11, a reflected light of the first projecting light may change, such that via the above optical path, the optical signal receiving region 51 may receive the first projecting beam corresponding to the movement of the finger 80 and thus obtain a new first image data. Then, the control unit 52 compares the first image data obtained by the optical signal receiving region 51 at different time points to compute a first displacement data. It is known to those skilled in the art that there are many ways to perform the correlation computation, so the details will not be described herein again.

FIG. 3B is a schematic view of another optical path according to the first embodiment of the present invention. As shown in FIG. 3B, first of all, when the first light source 30 is turned off, the second light source 40 is turned on. At this point, the second light source 40 produces a second projecting beam to a working surface 90.

Then, the second projecting beam is irradiated to the working surface 90 and reflected to the second lens 41. The second lens 41 refracts the second projecting beam to the optical signal receiving region 51. The optical signal receiving region 51 receives the second projecting beam to obtain a second image data.

When the computer input device 10 is moved by the user, a reflected light of the second projected light may change, such that via the above optical path, the optical signal receiving region 51 may receive the second projecting beam corresponding to the movement of the computer input device 10 and thus obtain a new second image data. Then, the control unit 52 compares the second image data obtained by the optical signal receiving region 51 at different time points to compute a second displacement data. It is known to those skilled in the art that there are many ways to perform the correlation computation, so the details will not be described herein again.

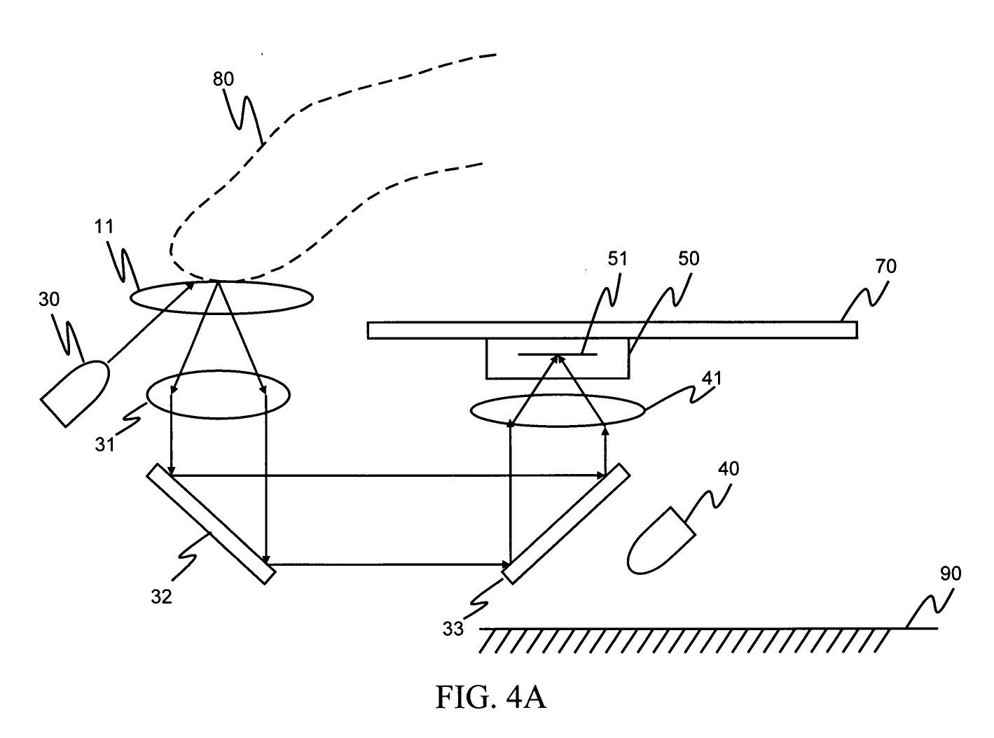

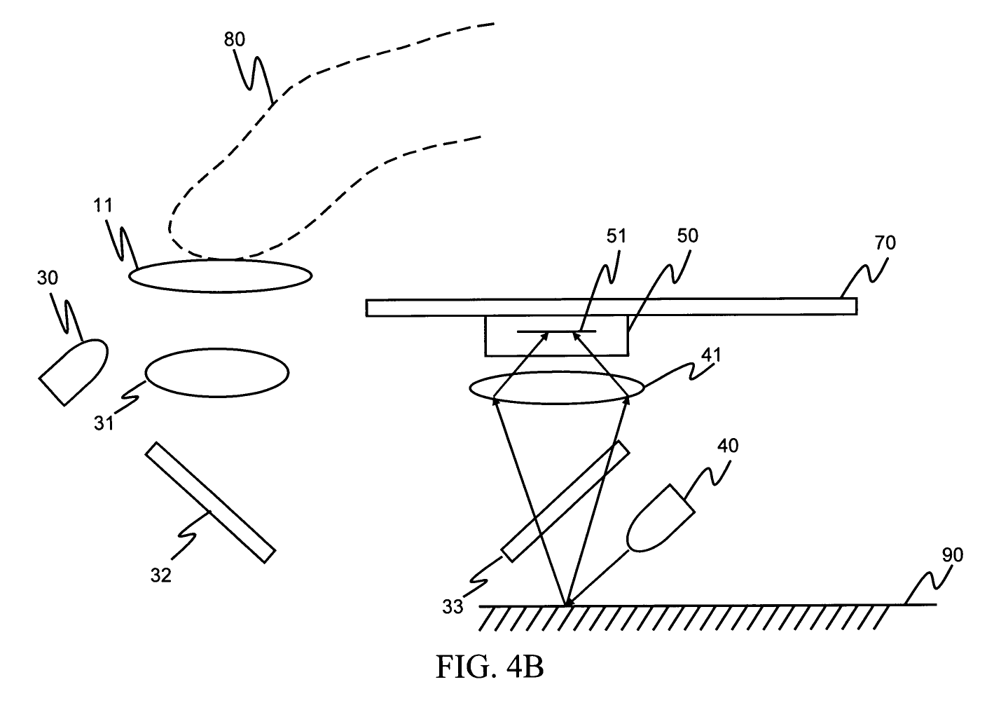

FIG. 4A is a schematic view of an optical path according to a second embodiment of the present invention. As shown in FIG. 4A, the computer input device 10 generally includes an optical sensing window 11, a first light source 30, a first lens 31, a first reflecting mirror 32, a second reflecting mirror 33, a second light source 40, a second lens 41, a sensor module 50, and a circuit board 70. The second embodiment is different from the first embodiment in that, a surface area of the second lens 41 in the second embodiment is smaller than that of the second lens 41 in the first embodiment. Further, in the second embodiment, the wavelengths of the first light source 30 and the second light source 40 are preferably different.

The first lens 31 and the optical sensing window 11 are substantially disposed in parallel. The first reflecting mirror 32 and the first lens 31 are set at an angle of approximately 45°. The second reflecting mirror 33 and the first reflecting mirror 32 are generally arranged in a mirror image relationship. The second lens 41 is disposed above the second reflecting mirror 33. The sensor module 50 is disposed above the second lens 41 and located on a lower surface of the circuit board 70. Further, the optical sensing window 11, the first light source 30, the first lens 31, the first reflecting mirror 32, and the second reflecting mirror 33 may constitute a first optical module. The second light source 40 and the second lens 41 may constitute a second optical module.

First of all, the control unit 52 sequentially controls the on and off of the first light source 30 and the second light source 40 in a time difference manner. When the first light source 30 is turned on, the second light source 40 is turned off. At this point, the first light source 30 produces a first projecting beam to the optical sensing window 11. Then, the first projecting beam is irradiated to a finger 80 and reflected to the first lens 31. The first lens 31 refracts the first projecting beam to the first reflecting mirror 32. Next, the first reflecting mirror 32 reflects the first projecting beam passing through the first lens 31 to the second reflecting mirror 33. The second reflecting mirror 33 reflects the first projecting beam reflected by the first reflecting mirror 32 to the second lens 41.

The second lens 41 is disposed between the second reflecting mirror 33 and the sensor module 50, for refracting the first projecting beam reflected by the second reflecting mirror 33 to the optical signal receiving region 51. The optical signal receiving region 51 receives the first projecting beam to obtain the first image data.

Next, when the finger 80 is moving on the optical sensing window 11, a reflected light of the first projecting light may change, such that via the above optical path, the optical signal receiving region 51 may receive the first projecting beam corresponding to the movement of the finger 80 and thus obtain a new first image data. Then, the control unit 52 compares the first image data obtained by the optical signal receiving region 51 at different time points to compute a first displacement data. It is known to those skilled in the art that there are many ways to perform the correlation computation, so the details will not be described herein again.

FIG. 4B is a schematic view of another optical path according to the second embodiment of the present invention. As shown in FIG. 4B, first of all, when the first light source 30 is turned off, the second light source 40 is turned on. At this point, the second light source 40 produces a second projecting beam to a working surface 90.

Then, the second projecting beam is irradiated to the working surface 90 and reflected to the second lens 41 through the second reflecting mirror 33. The second lens 41 refracts the second projecting beam to the optical signal receiving region 51. The optical signal receiving region 51 receives the second projecting beam to obtain a second image data.

When the computer input device 10 is moved by the user, a reflected light of the second projected light may change, such that via the above optical path, the optical signal receiving region 51 may receive the second projecting beam corresponding to the movement of the computer input device 10 and thus obtain a new second image data. Then, the control unit 52 compares the second image data obtained by the optical signal receiving region 51 at different time points to compute a second displacement data. It is known to those skilled in the art that there are many ways to perform the correlation computation, so the details will not be described herein again.

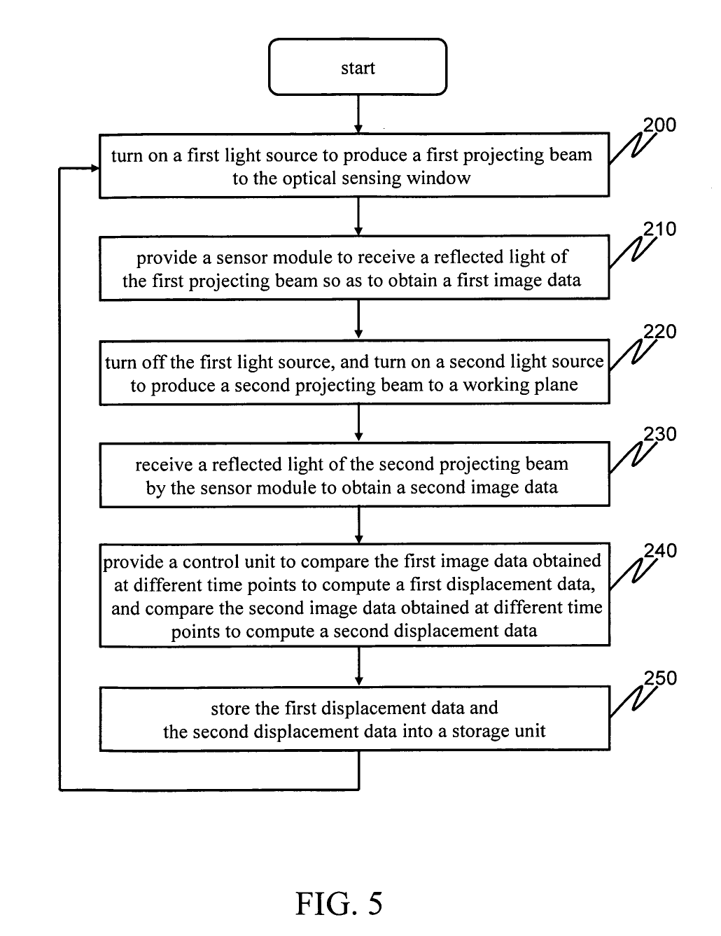

FIG. 5 is a flow chart of a time-difference-type data input processing method of the computer input device according to the present invention. Referring to FIG. 5, the time-difference-type data input processing method, applicable to an input processing between the computer input device with an optical sensing window and a computer, includes the following steps.

A first light source is turned on to produce a first projecting beam to the optical sensing window (Step 200). The intensity and light emitting time of the first light source may be automatically adjusted by a control unit or set and adjusted by the user.

When the first projecting beam is irradiated to the optical sensing window, a reflected light is produced, and thus a sensor module is provided to receive the reflected light of the first projecting beam so as to obtain a first image data (Step 210). The sensor module is capable of detecting an image data and computing a displacement data.

The first light source is turned off, and a second light source is turned on to produce a second projecting beam to a working surface (Step 220). The working surface is, for example, a desktop or a mouse pad. The first light source and the second light source may be of different wavelengths or of the same wavelength. The intensity and light emitting time of the second light source may be automatically adjusted by the control unit or set and adjusted by the user.

When the second projecting beam is irradiated to the working surface, a reflected light is produced, and the sensor module receives the reflected light of the second projecting beam to obtain a second image data (Step 230).

The control unit is provided to compare the first image data obtained at different time points to compute a first displacement data, and compare the second image data obtained at different time points to compute a second displacement data (Step 240). The first displacement data and the second displacement data may include a coordinate displacement on an X-axis, a coordinate displacement on a Y-axis, a displacement direction on the X-axis, and/or a displacement direction on the Y-axis.

The first displacement data and the second displacement data are stored into a storage unit (Step 250), and the process returns to Step 200. The storage unit includes a first register and a second register. The first displacement data is stored in the first register of the storage unit, and the second displacement data is stored in the second register of the storage unit.

In view of the above, through the computer input device with a time-difference-type bi-coordinate output, the time-difference-type data input processing method, and the sensor thereof provided by the present invention, two sets of light sources are utilized to alternately scan two different working surfaces in a time difference manner so as to obtain a desired image data. Then, a displacement coordinate data of each working surface is computed and stored in different registers. Finally, two coordinate values are selectively read by a microcontroller through different register addresses, respectively, and resolved into two different functions output to the computer end. In the present invention, as only one set of light source is driven to scan the image data at a time, the power is saved compared with the conventional way of driving two sets of light sources to scan the image data for a long time. Besides, the present invention only requires one optical sensor module, so that the fabrication cost of the computer input device is lowered, and the volume of the computer input device is also reduced.

What is claimed is:

1. A computer input device with a time-difference-type bi-coordinate output, comprising:
a first light source, for producing a first projecting beam in an alternating on and off manner;
a second light source, for producing a second projecting beam when the first light source is turned off, and stopping producing the second projecting beam when the first light source is turned on; and
a sensor module, for receiving the first projecting beam and the second projecting beam, the sensor module comprising:
an optical signal receiving region, for receiving the first projecting beam to obtain a first image data, and receiving the second projecting beam to obtain a second image data;
a control unit, for sequentially controlling the on and off of the first light source and the second light source in a time difference manner, comparing the first image data obtained by the optical signal receiving region at different time points to compute a first displacement data, and comparing the second image data obtained by the optical signal receiving region at different time points to compute a second displacement data; and
a storage unit, for storing the first displacement data and the second displacement data.

2. The computer input device with a time-difference-type bi-coordinate output according to claim 1, wherein the computer input device further comprises a microcontrol unit for reading the first displacement data and the second displacement data.

3. The computer input device with a time-difference-type bi-coordinate output according to claim 1, wherein the computer input device further comprises:
a first lens, for refracting the first projecting beam;
a first reflecting mirror, for reflecting the first projecting beam passing through the first lens;
a second reflecting mirror, for reflecting the first projecting beam reflected by the first reflecting mirror; and
a second lens, disposed between the second reflecting mirror and the sensor module, for refracting the first projecting beam reflected by the second reflecting mirror onto the optical signal receiving region, or refracting the second projecting beam onto the optical signal receiving region.

4. The computer input device with a time-difference-type bi-coordinate output according to claim 1, wherein the storage unit comprises a first register for storing the first displacement data, and a second register for storing the second displacement data.

5. A time-difference-type data input processing method of a computer input device, applicable to an input processing between the computer input device with an optical sensing window and a computer, the method comprising:
turning on a first light source to produce a first projecting beam to the optical sensing window;
providing a sensor module to receive a reflected light of the first projecting beam, so as to obtain a first image data;
turning off the first light source, and turning on a second light source to produce a second projecting beam to a working surface;
receiving a reflected light of the second projecting beam by the sensor module, so as to obtain a second image data;
provide a control unit to compare the first image data obtained at different time points to compute a first displacement data, and compare the second image data obtained at different time points to compute a second displacement data; and
storing the first displacement data and the second displacement data into a storage unit.

6. The time-difference-type data input processing method of a computer input device according to claim 5, wherein the first displacement data is stored in a first register of the storage unit, and the second displacement data is stored in a second register of the storage unit.

7. The time-difference-type data input processing method of a computer input device according to claim 5, wherein the first light source and the second light source are of the same wavelength.

8. The time-difference-type data input processing method of a computer input device according to claim 5, wherein the first light source and the second light source are of different wavelengths.

9. A sensor with a time-difference-type bi-coordinate output, comprising:
a first optical module, for producing a first projecting beam to an optical sensing window in an alternating on and off manner;
a second optical module, for producing a second projecting beam to a working surface when the first optical module is turned off, and stopping producing the second projecting beam to the working surface when the first optical module is turned on; and
a sensor module, for sequentially controlling an alternating on and off of the first and second optical modules, and receiving a reflected light of the first projecting beam and a reflected light of the second projecting beam.

10. The sensor according to claim 9, wherein the first projecting beam and the second projecting beam are of different wavelengths.
